(19) United States
(12) Patent Application Publication
(10) Pub. No.: US 2018/0144666 A1
(43) Pub. Date: May 24, 2018

(54) INFORMATION TAG PROTECTION APPARATUS AND METHODS FOR USING SAME

(71) Applicant: Carman Bailey, LaGrange, GA (US)

(72) Inventor: Carman Bailey, LaGrange, GA (US)

(21) Appl. No.: 15/818,535

(22) Filed: Nov. 20, 2017

Related U.S. Application Data
(60) Provisional application No. 62/424,212, filed on Nov. 18, 2016.

(51) Int. Cl. G09F 3/20

(52) U.S. Cl. CPC G09F 3/205

(57) ABSTRACT

Disclosed herein are information tag protection apparatuses and devices for protecting a tag for a lifting device. In one aspect, the information tag protection apparatus comprises a rectangular base to cover the tag, at least one horizontal strap attached along at least one edge of the rectangular base, and at least one vertical strap attached along at least one edge of the rectangular base. The at least one vertical strap may be configured goes through an eye of the lifting device, back into the rectangular base as the rectangular base along with the at least one horizontal strap is wrapped around the lifting device, until the at least one horizontal strap completely wrap around the lifting device with the tag secured underneath the rectangular base. Also disclosed herein are methods of using the disclosed apparatuses and devices.

### CROSS REFERENCE TO RELATED APPLICATIONS

This claims the benefit of priority to U.S. Provisional Patent Application Ser. No. 62/424,212, filed Nov. 18, 2016, which is hereby incorporated herein by reference in its entirety.

### FIELD OF INVENTION

The present invention relates to safety measures, apparatuses and devices for lifting slings, such as wire rope slings, and more specifically, tag protection means and apparatuses for protecting sling capacity tags that allow a user to determine safe limits of using the lifting slings.

### BACKGROUND OF THE INVENTION

Lifting slings are used for connecting a lifting device, such as a crane hook, to a load to be lifted. Lifting slings may be made using chains, wire ropes and even synthetic fiber, such as, for example, wire rope slings. Typically, the lifting slings have certain maximum capacity or load limits that define the maximum loads that the lifting slings can safely support. These maximum capacity limits are often mentioned on tags that are attached to the corresponding lifting slings. However, during the course of use, the tags may get dislodged or damaged. Further, the information on the tags may be illegible due to various reasons, such as wear and tear, or prolonged exposure to sunlight and water. This situation poses significant threat to life and property if a user uses slings for loads above the capacity limits. Moreover, guidelines of the Occupational Safety and Health Administration (OSHA) require that the capacity tag must be attached to the slings and it should be readable so that a user can ensure proper usage.

Accordingly, there remains a need for tag protection means and apparatuses for protecting capacity tags for lifting slings. This need and other needs are satisfied by the various aspects of the present disclosure.

### SUMMARY OF THE INVENTION

In accordance with the purposes of the invention, as embodied and broadly described herein, the invention, in one aspect, relates to an information tag protection apparatus for protecting a tag for a lifting device. The lifting device may be one a rigging device and a safety device. For example, the lifting device may be one of a rope sling and a safety sling. The tag may include one or more of capacity information, identification information and brand information. In further aspects, the invention also relates to methods for using the disclosed apparatuses and devices to protecting a tag for a lifting device.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1 shows a depiction of a front face of an information tag protection apparatus in accordance with an exemplary embodiment of the present invention.

FIG. 2 shows a depiction of a back face of the information tag protection apparatus of FIG. 1.

FIG. 3 shows a depiction of a first step to attach the information tag protection apparatus on a rope sling in accordance with an exemplary embodiment of the present invention.

FIG. 4 shows a depiction of the information tag protection apparatus removably secured and attached to the rope sling in accordance with an exemplary embodiment of the present invention.

FIG. 5 shows a depiction of a front face of an information tag protection apparatus in accordance with an exemplary embodiment of the present invention.

FIG. 6 shows a depiction of a back face of the information tag protection apparatus in accordance with an exemplary embodiment of the present invention.

FIG. 7 shows a depiction of a front face of an information tag protection apparatus in accordance with yet an exemplary embodiment of the present invention.

FIG. 8 shows a depiction of a back face of the information tag protection apparatus in accordance with yet an exemplary embodiment of the present invention.

FIG. 9 shows a depiction of another exemplary embodiment of the information tag protection apparatus on a rope sling in accordance with the present invention.

FIG. 10 shows a depiction of another exemplary embodiment of the information tag protection apparatus on a rope sling in accordance with the present invention.

FIG. 11 shows a depiction of another exemplary embodiment of the information tag protection apparatus on a rope sling in accordance with the present invention.

FIG. 12 shows a depiction of another exemplary embodiment of the information tag protection apparatus on a rope sling in accordance with the present invention.

### DETAILED DESCRIPTION OF THE INVENTION

The present invention can be understood more readily by reference to the following detailed description of the invention and the Examples included therein.

Before the present articles, systems, devices, apparatuses and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

As used in the specification and the appended claims, the singular forms “a,” “an” and “the” include plural referents unless the context clearly dictates otherwise. Thus, for example, reference to “a strap” includes two or more straps.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices and articles of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Devices and Apparatuses

As briefly described above, the present disclosure relates, in various aspects, to a devices and apparatuses for protecting a tag for a lifting device. In further aspects, the lifting device may be one a rigging device or a safety device or a combination thereof. For example, the lifting device may be one of a rope sling and a safety sling. The tag may include one or more of capacity information, identification information and brand information.

In further aspects, the tag may be one of a paper tag, a cloth tag, a plastic tag, a metal tag and an RFID tag, or a combination thereof. The information tag protection apparatus may include a base to cover the tag. In some aspects, the base can have a substantially rectangular or square shape. In other aspects, the base can have a non-rectangular shape, such as a polygon or circular shape. In still further aspects, the base may protect the tag from at least one of being dislodged and being damaged. Further, the base may be made of a material that is both pliable and tough; for example, the base may be made of neoprene fabric. In still further aspects, the base may comprise a plurality of base portions.

In further aspects, the base may be made of reinforced textile products, such as, and without limitation, coated woven and laminated woven materials. In yet further aspects, the base can comprise a solid shell casing, such as, for example, from a metal, polymer, ceramic, fiberglass, or composite material, or combinations thereof. In even further aspects, the base can further comprise a coating, such as, and without limitation, a film, laminate, epoxy, or the like.

In various aspects, the information tag protection apparatus may further comprise at least one horizontal strap attached along at least one edge of the rectangular base, and at least one vertical strap attached along at least one edge of the rectangular base. In further aspects, apparatus may be configured such that the at least one vertical strap is attached in a direction perpendicular to the at least one horizontal strap. In yet further aspects, the at least one horizontal strap may tightly secure the tag in place on the lifting device. In even further aspects, the at least one vertical strap may keep the rectangular base from sliding down the lifting device.

In various further aspects, the information tag protection apparatus and the tag comply with the guidelines of the Occupational Safety and Health Administration (OSHA). For example, the guidelines include that the tag must be attached and readable so that a user can ensure proper usage.

In further aspects, the rectangular base may comprise a window or viewable area wherein the information on the tag is visible. In still further aspects, the window can comprise a transparent, pliable and tough material, wherein the information on the tag is visible through the window. For example, the window may be made of gauge clear vinyl. In yet further aspects, the window or viewable area can comprise a screen or a transparent, tough, impact-resistant material, such as, and without limitation, poly(methyl methacrylate) (PMMA), acrylic, or acrylic glass, or the like.

According to some aspects, the number of straps in the at least one horizontal strap may be based on the size of the information tag protection apparatus. For example, a smaller information tag protection apparatus may include two horizontal straps and a bigger information tag protection apparatus may include three horizontal straps.

In one aspect, the present disclosure provides an information tag protection apparatus that may include a rectangular base to cover the tag. In further aspects, the information tag protection apparatus may include two horizontal straps, wherein each horizontal strap extending away from the rectangular base along each of the longer two opposite edges of the rectangular base respectively. Further, the information tag protection apparatus may include a single vertical strap extending away from the rectangular base along one of the smaller edges of the rectangular base. Further, the edges of the rectangular base, the two horizontal straps and the one vertical strap may include a connecting means or fastener to secure the rectangular base, the one vertical strap and the two horizontal straps on a lifting device such as a rope sling. For example, the connecting means or fastener may include buttons and buttonholes. Alternatively, the fastener means may include hook and loop (e.g., Velcro™) fasteners. The edges of the rectangular base may be lined with hook and loop fastener on both sides. Further, the two horizontal straps and the one vertical strap may include a hook and loop fastener on just one side. For example, the hook and loop fastener may be attached via at least one adhesive chemical, an adhesive tape and sewing.

In a further aspect, the one vertical strap may go through an eye of the rope sling, and then go back into the rectangular base as the rectangular base along with the two horizontal straps is wrapped around the rope sling, until the two horizontal straps completely wrap around the rope sling with the tag secured underneath. The hook and loop fastener on the vertical strap engages with the hook and loop fastener on the rectangular base, and the hook and loop fastener on the rectangular base engages with the hook and loop fastener on each horizontal strap as the two horizontal straps wrap around the rope sling.

In a further aspect, the hook and loop fastener may include a male portion with hooks on one side and a female portion with loops on the other side. Accordingly, the two longer sides of the rectangular base, the shorter side of the rectangular base that aligns with the one vertical strap and the one vertical strap may include female hook and loop strips on one side of the information tag protection apparatus. Further, the shorter edge of the rectangular base opposite to the shorter edge that aligns with the one vertical strap and the two longer sides of the rectangular base along with the two horizontal straps may include male hook and loop strips on the other side of the information tag protection apparatus. Therefore, the one vertical strap may go through the eye of the rope sling, and may be turned back towards the rectangular base such that the hook and loop female strip of the one vertical strap may be visible, then the rectangular base along with the two horizontal straps may be wrapped around the rope sling, until the two horizontal straps completely wrap around the rope sling with the tag secured underneath. The hook and loop male strip on the rectangular base may engage with the hook and loop female strip on the vertical strap, and the hook and loop female strip on the horizontal straps may engage with the hook and loop male strip of the rectangular base as the two horizontal straps wrap around the rope sling. In some aspects, the position of the hook and loop male strips and the hook and loop female strips may be interchanged.

In alternate aspects, the alignment of the horizontal straps and the vertical strap may be interchanged, such that each horizontal strap extending away from the rectangular base along each of the shorter two opposite edges of the rectangular base respectively. Further, the at least one vertical strap includes a single vertical strap extending away from the rectangular base along one of the longer edges of the rectangular base.

In further aspects, the at least one horizontal strap includes two horizontal straps forming a lining along each of the longer two opposite edges of the rectangular base respectively, wherein the at least one vertical strap includes a single vertical strap forming a lining along one of the smaller edges of the rectangular base, wherein the length of each horizontal strap is longer than the length of the longer edge of the rectangular base and the length of the vertical strap is longer than the length of the smaller edge of the rectangular base.

In other aspects of the present invention, an information tag protection apparatus may comprise a plurality of straps, for example, three horizontal straps. In further aspects, the apparatus may comprise two horizontal straps extending away from the rectangular base along each of the longer two opposite edges of the rectangular base respectively and a third horizontal strap extending away from the rectangular base between the two horizontal straps. In still further aspects, the third horizontal strap may be attached to at least one the shorter edges of the rectangular base.

In further aspects, the information tag protection apparatus may comprise a single vertical strap extending away from the rectangular base along one of the smaller edges of the rectangular base. In still further aspects, the edges of the rectangular base, the three horizontal straps and the one vertical strap may include a fastener means to secure the rectangular base, the one vertical strap and the three horizontal straps on a rope sling. For example, the fastener means may include buttons and buttonholes. Alternatively, the fastener means may include hook and loop fastener. In further aspects, the edges of the rectangular base may be lined with hook and loop fastener on both sides. In still further aspects, the three horizontal straps and the one vertical strap may comprise a hook and loop fastener on just one side. In even further aspects, the one vertical strap may go through an eye of the rope sling, and may then go back into the rectangular base as the rectangular base along with the three horizontal straps may be wrapped around the rope sling, until the three horizontal straps completely wrap around the rope sling with the tag secured underneath. The hook and loop fastener on the vertical strap may engage with the hook and loop fastener on the rectangular base, and the hook and loop fastener on one side of each horizontal strap may engage with the hook and loop fastener on the other side of the rectangular base as the three horizontal straps wrap around the rope sling.

In various aspects, the rectangular base may be shaped in any suitable shape, such as a square, a rectangle, a triangle, a circle, an oval, and a polygon. The at least one horizontal strap may be attached along at least one edge of the base. Further, at least one vertical strap attached to the base such that the direction of the at least one vertical strap is perpendicular to the direction of the at least one horizontal strap.

In one aspect, the base can have any desired length or width. In further aspects, the base can have a length in the range of from about 2 inches to about 60 inches and a width of from about 2 inches to about 30 inches, including exemplary dimensions of 3.5 inches by 7 inches, 4.5 inches by 8.5 inches, 4.5 inches by 17 inches, 4.5 inches by 7 inches, 5.25 inches by 8.5 inches, or 5.25 inches by 17 inches. In still further aspects, the dimensions can comprise any dimension within the above exemplified ranges.

In one aspect, the straps can have any desired length. In further aspects, the strap can have a length in the range of from about 0.5 inches to about 60 inches, including exemplary lengths of 0.5 inches, 1 inches, 1.5 inches, 2 inches, 2.5 inches, 3 inches, 4 inches, 5 inches, 6 inches, 8 inches, 9 inches, or 10 inches, or greater. In still further aspects, the length can comprise any length within the above exemplified ranges.

In various aspects, the invention also relates to methods for using the disclosed information tag protection apparatuses. In further aspects, the disclosed information tag protection apparatus and methods may be used for protecting tags on other equipment, such as electrical wires.

In one aspect, the method may comprise pulling the at least one vertical strap through an eye of the lifting device (such as a wire rope sling) and back towards the rectangular base. In further aspects, the method may comprise wrapping the rectangular base along with the at least one horizontal strap around the rope sling until the at least one horizontal strap completely wraps the rope sling with the tag secured underneath the rectangular base.

According to various aspects of the present invention, a method for providing a safety measure for lifting a load using a rope sling is also disclosed. In further aspects, the method may comprise observing a tag including the capacity information of the rope sling. The tag may provide information about a predetermined maximum static force, which may be applied to the rope sling during lifting. Further, the tag may be protected by providing and/or using a disclosed information tag protection apparatus. In further aspects, the method may then comprise loading the rope sling based on the predetermined maximum static force.

In further aspects, the information tag protection apparatus may include a rectangular base to cover a tag, at least one horizontal strap attached along at least one edge of the rectangular base, and at least one vertical strap attached along at least one edge of the rectangular base. In a further aspect, the method for attaching the information tag protection apparatus for the rope sling may comprise pulling the at least one vertical strap through an eye of the rope sling and back towards the rectangular base and then wrapping the rectangular base along with the at least one horizontal strap around the rope sling until the at least one horizontal strap completely wraps around the rope sling with the tag secured underneath. The information tag protection apparatus may be configured to be removably secured or attached to the rope sling. The rectangular base may cover and protect the tag from at least one of being dislodged and being damaged. Further, the at least one horizontal strap may tightly secure the tag in place on the lifting device and the at least one vertical strap may keep the rectangular base from sliding down the lifting device.

### C. Drawings

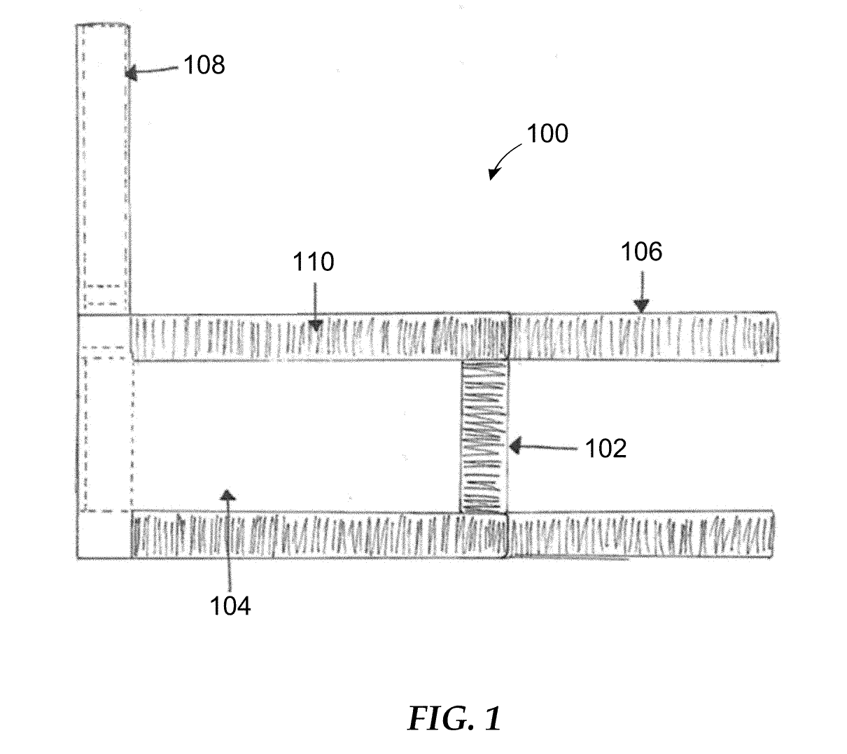

According to various aspects of the invention, the disclosed information tag protection apparatus and devices can comprise multiple configurations. For example, various exemplary embodiments of the information tag protection apparatuses and methods are shown in FIGS. 1-12.

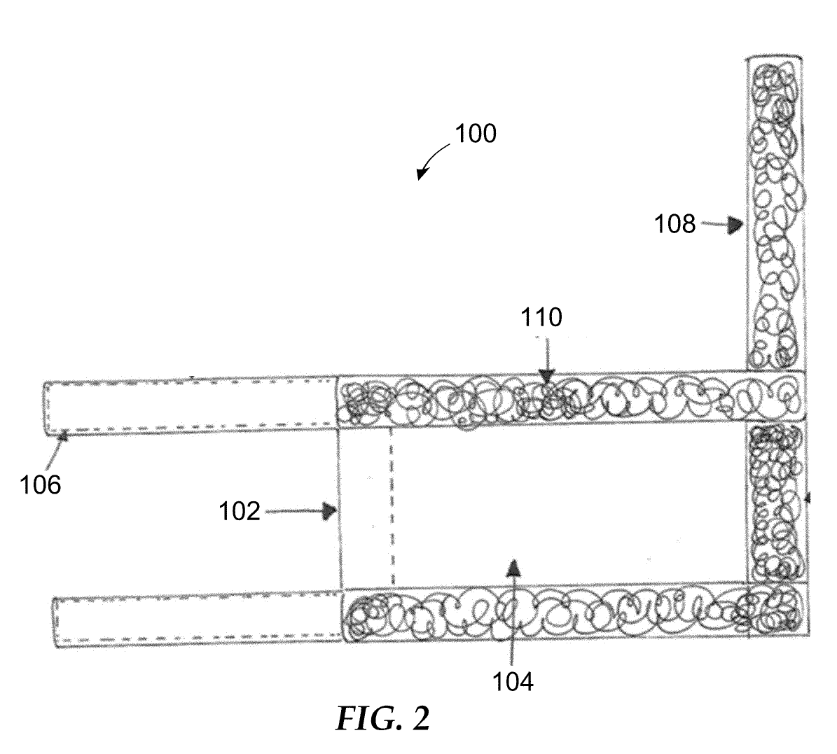

In further aspects, FIGS. 1-4 show an exemplary information tag protection apparatus 100 for detachably securing a tag to a lifting device. In still further aspects, FIG. 1 shows a depiction of a front view of the information tag protection apparatus 100 and FIG. 2 shows a depiction of a back view of the information tag protection apparatus 100. In these embodiments, the information tag protection apparatus 100 comprises a rectangular base 102 to cover the tag with the tag cover portion 104, two horizontal straps 106 extending away from the rectangular base 102 along each of the longer two opposite edges of the rectangular base 102 respectively and one vertical strap extending away from the rectangular base 102 along one of the shorter edges of the rectangular base 102. Further, the edges of the rectangular base 102, the two horizontal straps and the one vertical strap include a fastener 110 to secure the rectangular base 102, the one vertical strap 108 and the two horizontal straps 106 on a rope sling. The fastener 110 may include hook and loop (e.g., Velcro™) fastener, wherein the edges of the rectangular base 102 are lined with fastener 110 on both sides. Further, the two horizontal straps 106 and the one vertical strap 108 include fastener 110 on just one side.

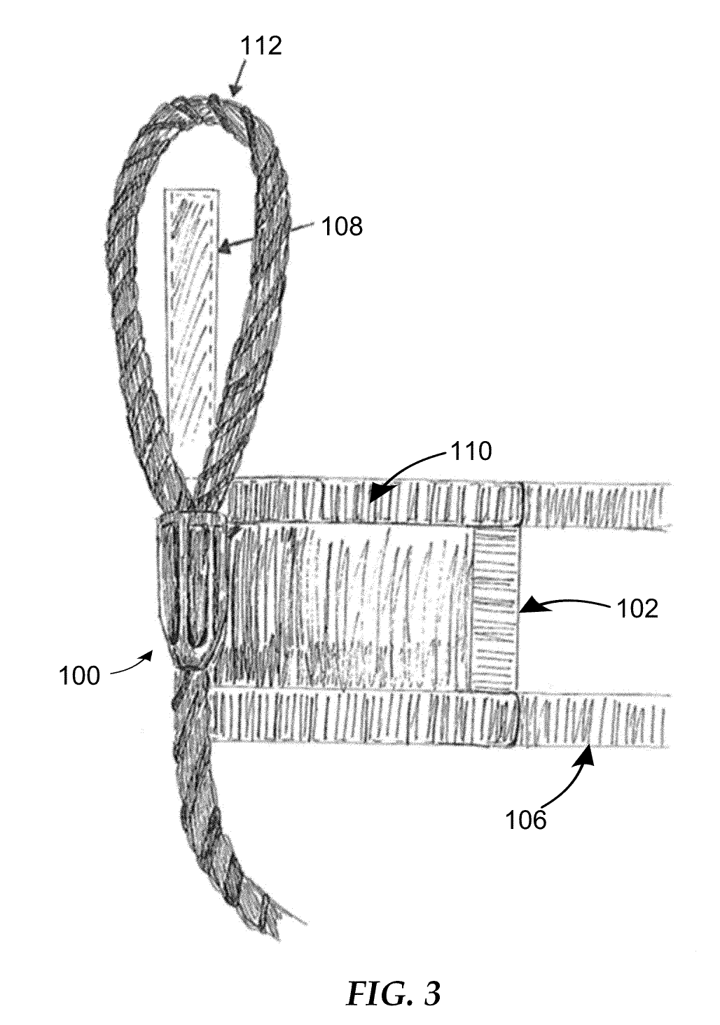

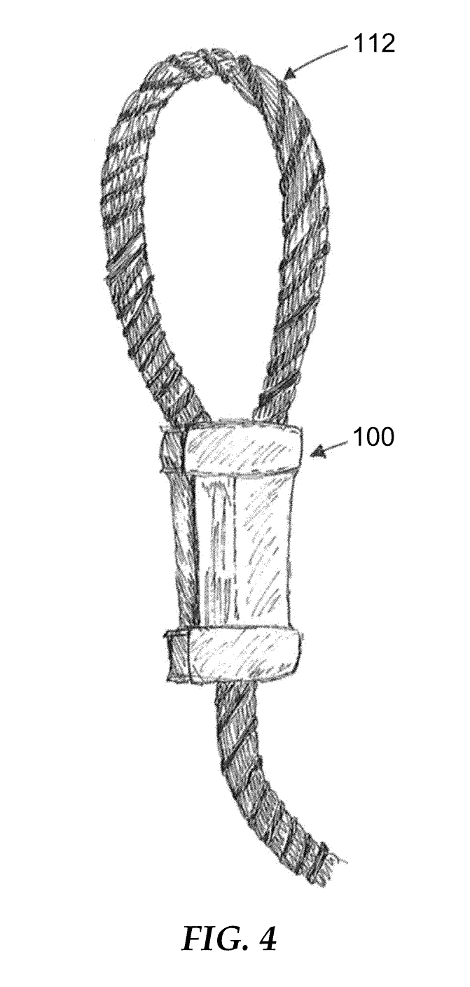

Additionally, as shown in FIGS. 3-4, the information tag protection apparatus 100 is securely removably attached to the lifting device 112. As shown, the lifting device 112 is a rope sling with an eye. FIG. 3 shows a depiction of a first step to attach the information tag protection apparatus 100 on the rope sling 112. The one vertical strap goes through the eye of the rope sling, back into the rectangular base 102 as the rectangular base 102 along with the two horizontal straps 106 is wrapped around the rope sling 112, until the two horizontal straps completely wrap around the rope sling with the tag secured underneath as shown in FIG. 4. The fastener 110 on the one vertical strap engages with the fastener 110 on the rectangular base, and the fastener 110 on the horizontal straps engage with the fastener 110 on the other side of the rectangular base as the horizontal straps wrap around the lifting device 112.

Moreover, the fastener 110 includes a male fastener strip with hooks on one side and a female fastener strip with loops on the other side. Therefore, the two longer sides of the rectangular base 102, the shorter side of the rectangular base 102 that aligns with the vertical strap 108 and the vertical strap include female fastener strips on one side. The shorter edge of the rectangular base 102 opposite to the shorter edge that aligns with the vertical strap 108, and the two longer sides of the rectangular base 102 along with the two horizontal straps 106 include male fastener strips. The position of the fastener male strips and the female strips may be interchanged in another embodiment.

Therefore, the single vertical strap 108 goes through an eye of the rope sling 112, and is turned back towards the rectangular base 102 such that the fastener female strip of the one vertical strap 108 is visible, then the rectangular base 102 along with the two horizontal straps 106 is wrapped around the rope sling 112, until the two horizontal straps 106 completely wrap around the rope sling 112 with the tag secured underneath, wherein the fastener male strip on the rectangular base 102 engages with the fastener female strip on the vertical strap 108, and the fastener female strip on the horizontal straps 106 engage with the fastener male strip of the rectangular base 102 as the horizontal straps 106 wrap around the rope sling 112. As shown in FIG. 4, the rectangular base covers and protects the tag from at least one of being dislodged and being damaged.

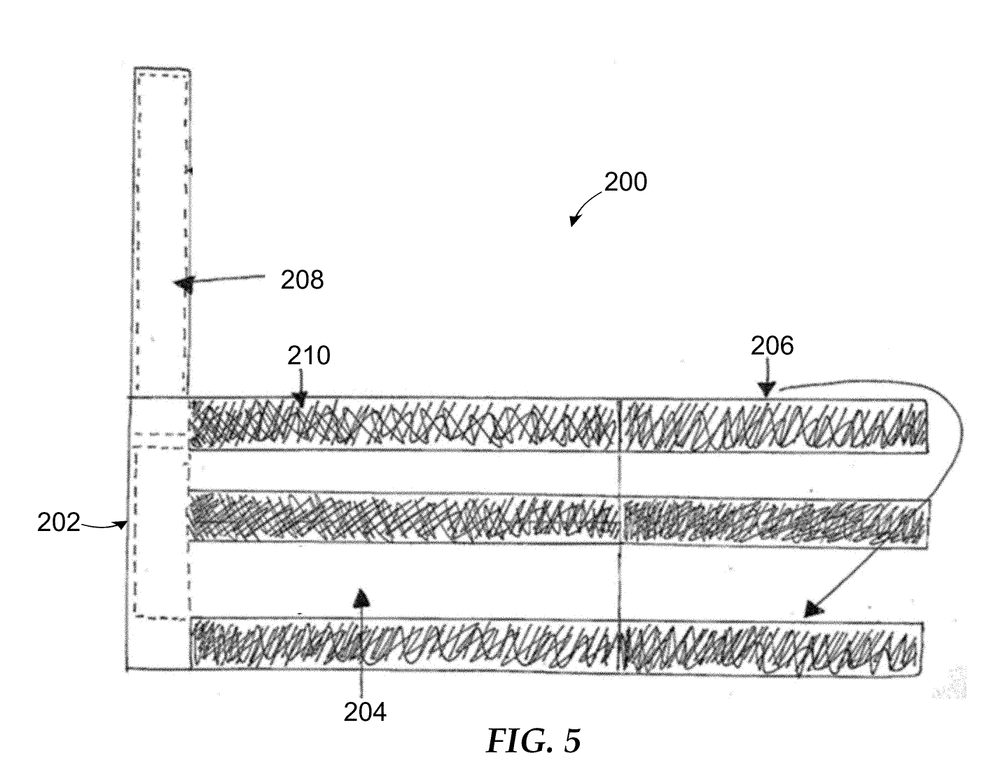

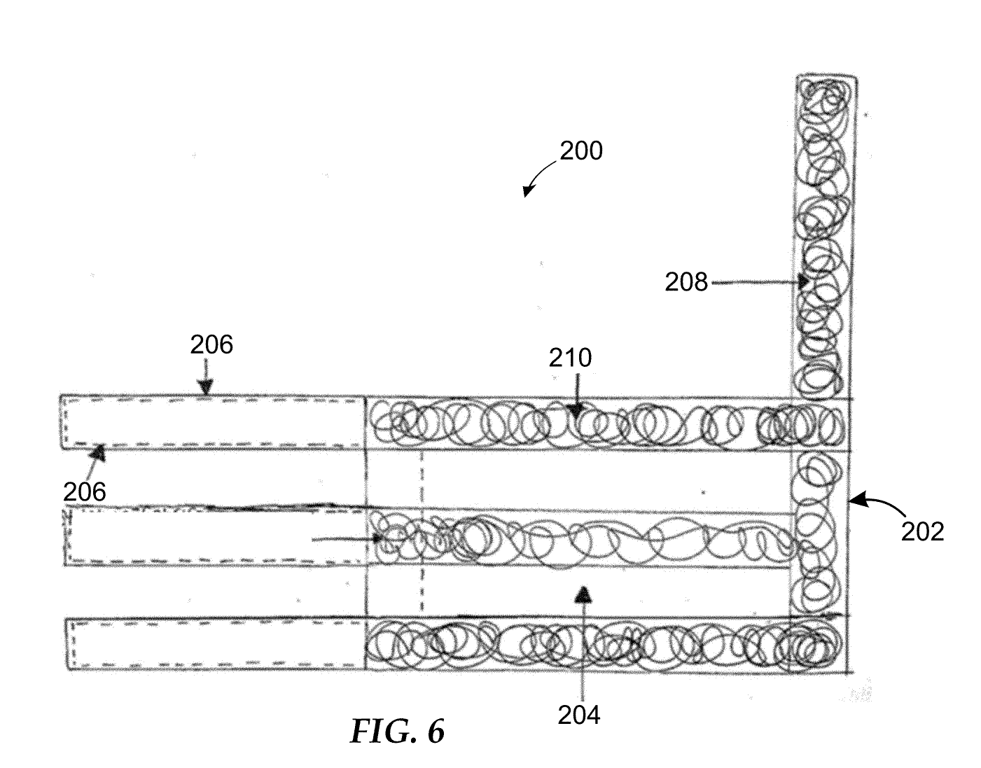

In various further aspects, FIGS. 5-6 show an information tag protection apparatus 200 according to further exemplary embodiments of the present invention. In these embodiments, information tag protection apparatus 200 includes three horizontal straps 206 and one vertical strap 208. FIG. 5 shows a depiction of a front view of an information tag protection apparatus 200 and the FIG. 6 shows a depiction of a back view of the information tag protection apparatus 200. The two horizontal straps 206 extending away from the rectangular base 202 along each of the longer two opposite edges of the rectangular base 202 respectively. This is similar to the information tag protection apparatus 100 of FIGS. 1-4. The third horizontal strap 206 extending away from the rectangular base 202 between the two horizontal straps 206. The third horizontal strap 206 may be attached to at least one the shorter edges of the rectangular base 202.

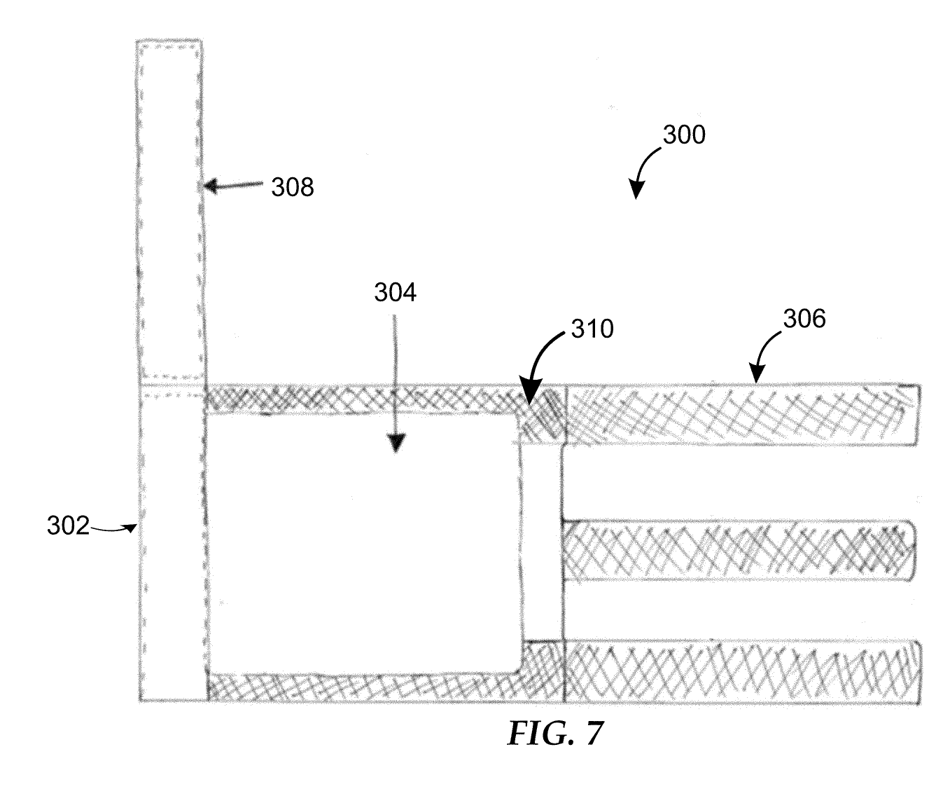

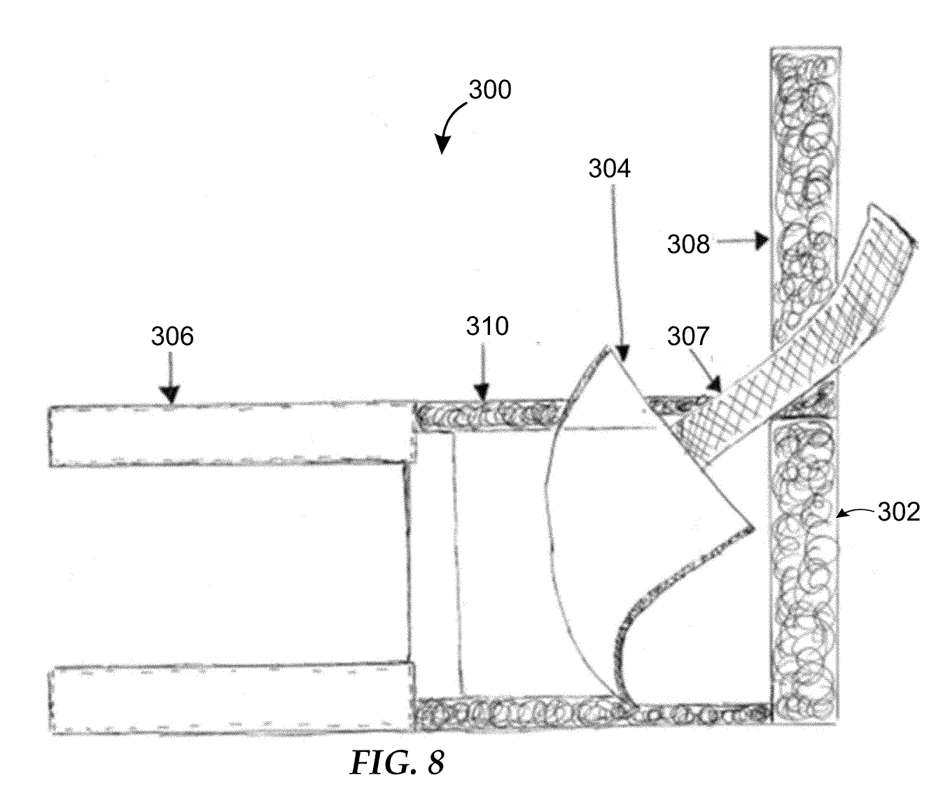

In various further aspects, FIGS. 7-8 show an information tag protection apparatus 300 according to further exemplary embodiments of the present invention. FIG. 7 shows a depiction of a front view of an information tag protection apparatus 300 and the FIG. 8 shows a depiction of a back view of the information tag protection apparatus 300. In these embodiments, information tag protection apparatus 300 includes two or three horizontal straps 306 and one vertical strap 308. The tag cover portion of rectangular base 302 may include a viewing window 305 made using a transparent, pliable and tough material, wherein the information on the tag is visible through the window 305. For example, the window 305 may be made of gauge clear vinyl as shown in FIG. 7. The window 305 allows a user of the corresponding rope sling to easily obtain the capacity information of the rope sling. Further, the rectangular base 302 may include two layers, such that a first layer includes a viewing window 305 and a second layer 304 is an opaque, removable background layer. The third horizontal strap 307 may be attached to the second layer 304. Further, the second layer 304 may be moved away from the first layers as shown in FIG. 8. Moreover, a tag may be placed between the first layer and the second layer.

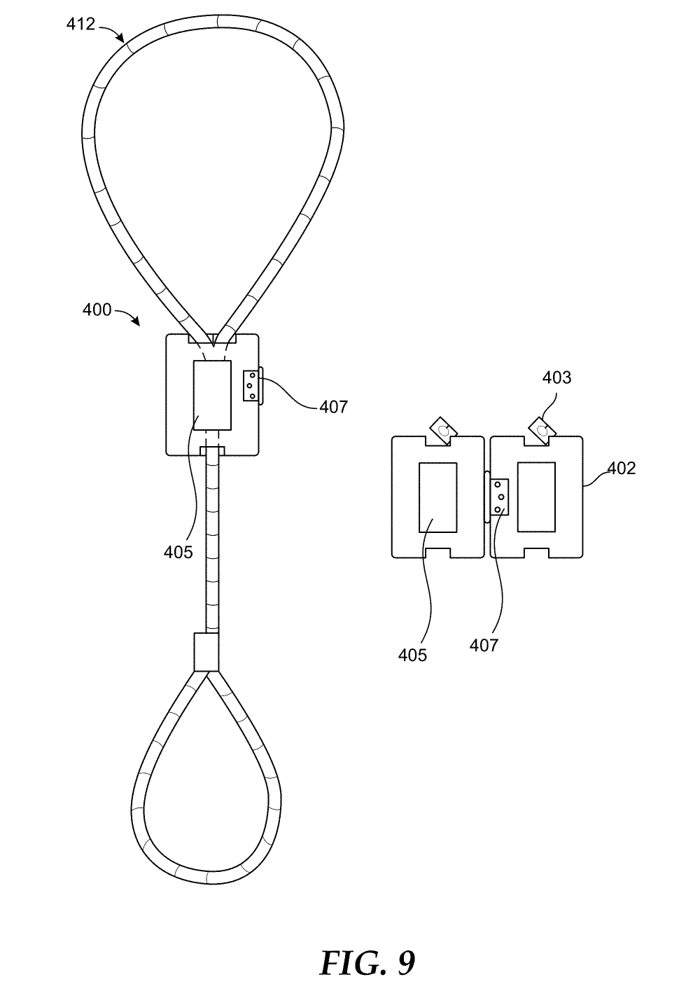

In various further aspects, FIGS. 9-12 show various exemplary embodiments of another information tag protection apparatus 400 for securely attaching a tag to a lifting device 412. FIG. 9 shows a depiction of an opened view of the information tag protection apparatus 400 and a depiction of the information tag protection apparatus 400 attached to a rope sling 412. In these embodiments, the information tag protection apparatus 400 comprises a solid shell base 402 to cover the tag, comprising two halves connected by a pivoting means 407, such as, for example, a hinge. In some aspects, the apparatus can have two or more pivoting means, or can otherwise be double hinged. The two halves of the base are releasably connected to allow for the base 402 to be opened and closed, such that when closed, the base can be secured on a rope sling. In further aspects, when the two halves are closed, one or more aperture portions, for example, tag slits 403 are formed at the top and/or bottom of the base 402 configured to secure different portions of the lifting device 412. The aperture portions 403 can comprise securing mechanisms that are attached to or integral with the base 402.

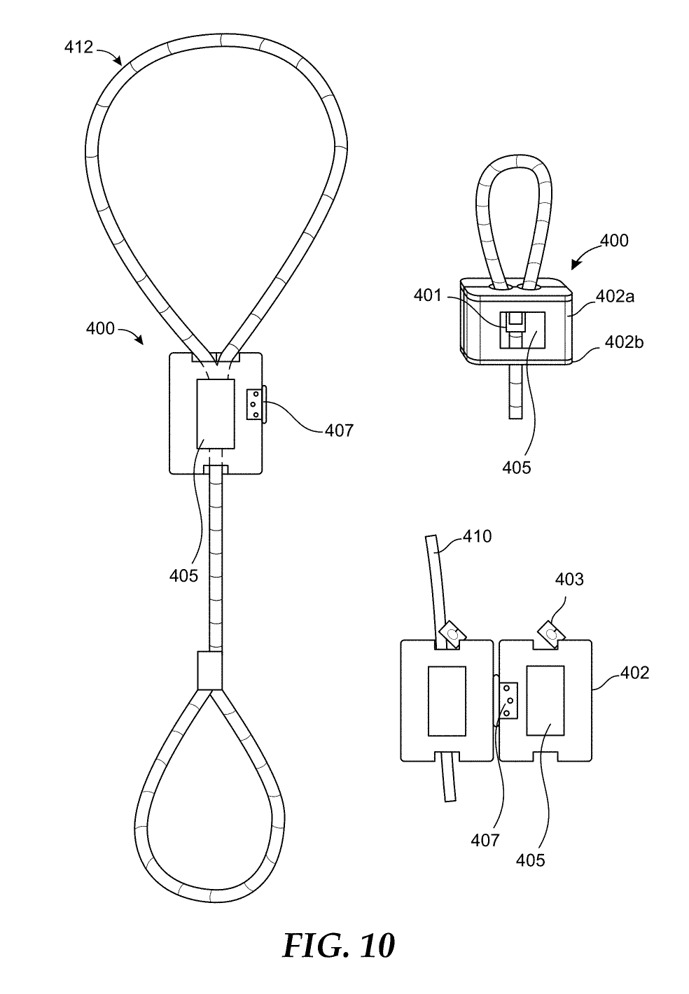

FIG. 10 shows other embodiments of an opened information tag protection apparatus 400 and a depiction of the information tag protection apparatus 400 attached to a rope sling 412. In these embodiments, the information tag protection apparatus 400 comprises a shell base comprises a first base portion 402a and second base portion 402b using different materials, for example, a sold material and a soft material. In some aspects, the base may comprise a fastening means 410, such as a clamp to keep the two halves connected and secured to the rope sling. In some embodiments, the fastening means 410 can comprise a clamp, clip, snap, fitting, clasp, hook and loop fastener, tie wraps, hook and latch, loop and tie, or similar mechanism. In further aspects, the base can comprise a button or other release mechanism to release the connection and open the two halves. In still further aspects, the base can have a rectangular, oval, round, or cylindrical shape. The base may include a viewing window 405 made using a transparent, tough, impact resistant material, wherein the information on the tag 401 is visible through the window. For example, the window 405 may be made of poly (methyl methacrylate) (PMMA), acrylic, or acrylic glass, or the like. As shown, the window 405 allows a user of the corresponding rope sling to easily obtain the capacity information from the tag 401.

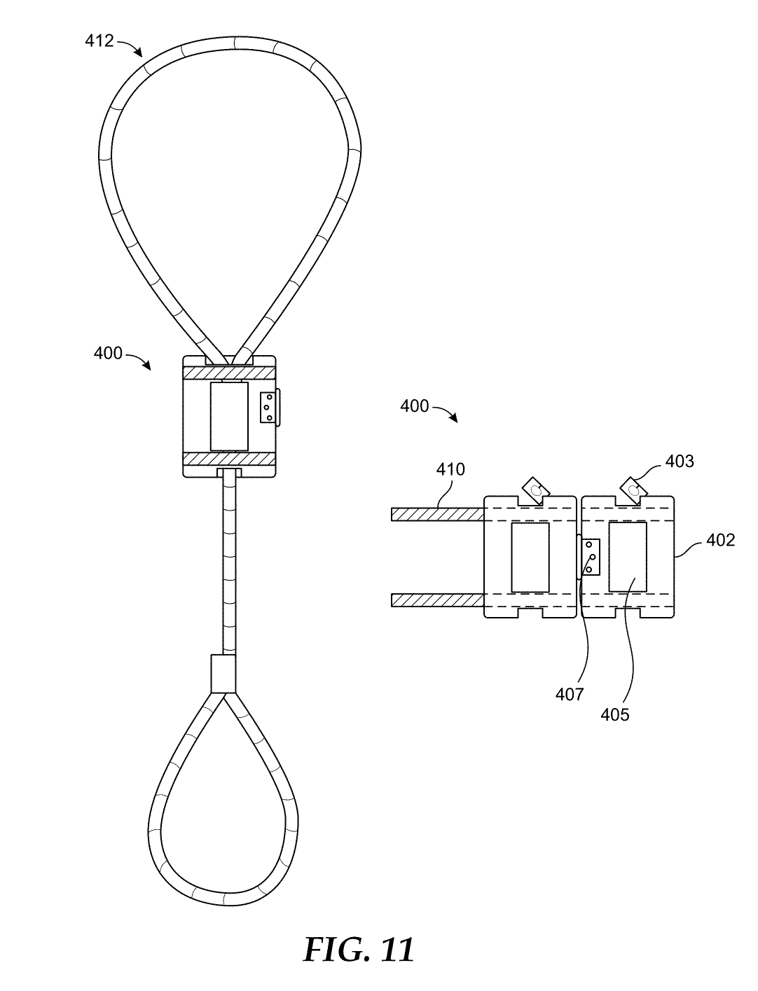

As shown in FIG. 11, the information tag protection apparatus 400 can be configured to function on oversized rope slings 412. In some aspects, the base 402 can comprise a soft or flexible portion and a solid or stiff portion, and can be configured such that the hard portion of base is substantially the only portion of the base that is contact and/or securing the rope sling. In yet further aspects, when the two halves are closed, the base may be configured to form two apertures portions 403 at a top portion of the base for receiving the rope sling. In various further aspects, the base 402 may comprise a tag slit 403 for securely holding the rope in place, for example, in the aperture. In some aspects, the fastening means 410 can be attached on the inner or outer face, and can substantially wrap around the body of the base to hold the base halves in the closed position.

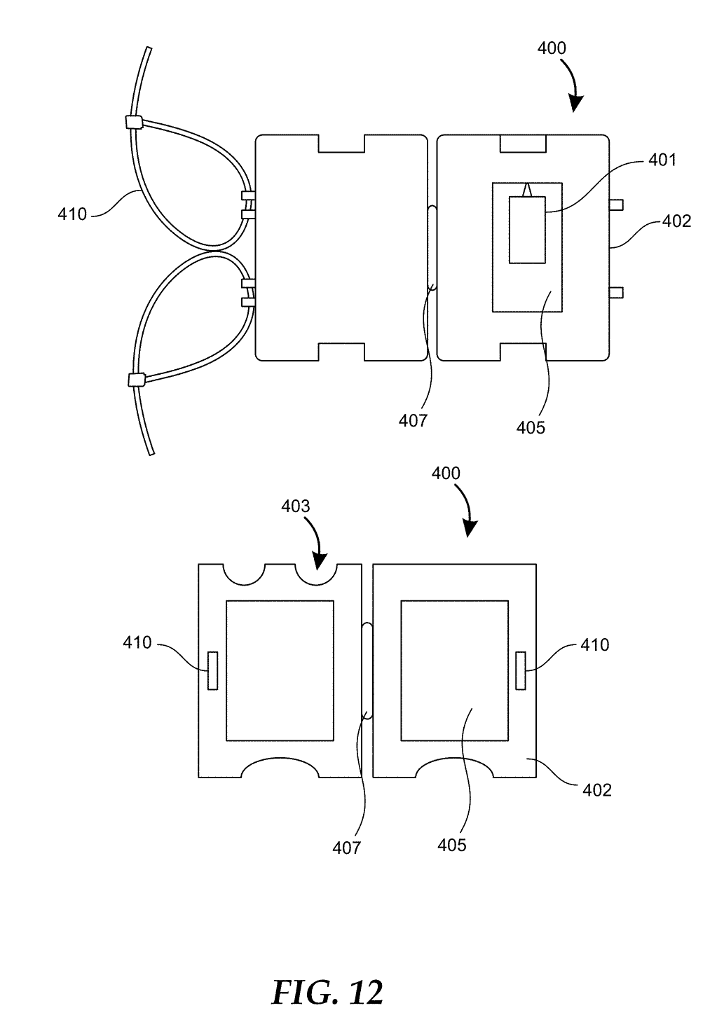

As shown in FIG. 12, instead of hinges or buttons, the base 402 can use a fastening means 410 such as hook and loop fasteners, tie wraps or the like to be held closed. In further aspects, the base 402 can comprise a plurality of securing and/or connecting means, such as, and without limitation, hook and loop at one portion and clamping mechanism on another portion of the base. As shown, the base may comprise a fastener or vertical strap 408 across the center. In other aspects, the base 402 can be held in the closed position by using zip ties and corresponding loops attached on each of the halves. For example, when the two base halves are in the closed position, the loops can be lined up to allow a zip tie to be inserted through the loops and tightened to keep the base in the closed position and secured to the rope sling.

### D. Aspects

The disclosed devices, systems, and methods include at least the following aspects: Aspect 1: An information tag protection apparatus for protecting a tag for a lifting device, the information tag protection apparatus comprising: a rectangular base to cover the tag; at least one horizontal strap attached along at least one edge of the rectangular base; and at least one vertical strap attached along at least one edge of the rectangular base, such that the at least one vertical strap is attached in a direction perpendicular to the at least one horizontal strap; wherein the at least one vertical strap goes through an eye of the lifting device, back into the rectangular base as the rectangular base along with the at least one horizontal strap is wrapped around the lifting device, until the at least one horizontal strap completely wrap around the lifting device with the tag secured underneath the rectangular base.

Aspect 2: The information tag protection apparatus of any preceding claim, wherein the tag including one or more of capacity information, identification information and brand information.

Aspect 3: The information tag protection apparatus of any preceding claim, wherein protecting the tag includes keeping the information on the tag legible.

Aspect 4: The information tag protection apparatus of any preceding claim, wherein the tag and the information tag protection apparatus comply with the guidelines of the Occupational Safety and Health Administration (OSHA), wherein the guidelines include that the tag must me attached and readable so that a user can ensure proper usage.

Aspect 5: The information tag protection apparatus of any preceding claim, wherein the tag is at least one of a paper tag, a cloth tag, a plastic tag, a metal tag and an RFID tag.

Aspect 6: The information tag protection apparatus of any preceding claim is configured to securely removably attach to the lifting device.

Aspect 7: The information tag protection apparatus of any preceding claim, wherein the lifting device is at least one of a rigging device and a safety device.

Aspect 8: The information tag protection apparatus of any preceding claim, wherein the lifting device is at least one of a rope sling and a safety sling.

Aspect 9: The information tag protection apparatus of any preceding claim, wherein the rectangular base covers and protects the tag from at least one of being dislodged and being damaged.

Aspect 10: The information tag protection apparatus of any preceding claim, wherein the rectangular base is made of a material that is both pliable and tough.

Aspect 11: The information tag protection apparatus of any preceding claim, wherein the rectangular base is made of neoprene fabric.

Aspect 12: The information tag protection apparatus of any preceding claim, wherein the rectangular base is made of scuba knit fabric neoprene polyester spandex.

Aspect 13: The information tag protection apparatus of any preceding claim, wherein the rectangular base includes a window made using a transparent, pliable and tough material, wherein the information on the tag is visible through the window.

Aspect 14: The information tag protection apparatus of any preceding claim, wherein the window is made of gauge clear vinyl or acrylic.

Aspect 15: The information tag protection apparatus of any preceding claim, wherein the at least one horizontal strap tightly secures the tag in place on the lifting device.

Aspect 16: The information tag protection apparatus of any preceding claim, wherein the at least one vertical strap keeps the rectangular base from sliding down the lifting device.

Aspect 17: The information tag protection apparatus of any preceding claim, wherein the at least one horizontal strap includes two horizontal straps, wherein each horizontal strap extending away from the rectangular base along each of the longer two opposite edges of the rectangular base respectively, wherein the at least one vertical strap includes a single vertical strap extending away from the rectangular base along one of the shorter edges of the rectangular base.

Aspect 18: The information tag protection apparatus of any preceding claim, wherein the edges of the rectangular base, the two horizontal straps and the one vertical strap include a fastener means to secure the rectangular base, the one vertical strap and the two horizontal straps on a rope sling.

Aspect 19: The information tag protection apparatus of any preceding claim, wherein the fastener means include buttons and buttonholes.

Aspect 20: The information tag protection apparatus of any preceding claim, wherein the fastener means include hook and loop fastener, wherein the edges of the rectangular base are lined with hook and loop fastener on both sides, wherein the two horizontal straps and the one vertical strap include a hook and loop fastener on just one side.

Aspect 21: The information tag protection apparatus of any preceding claim, wherein the hook and loop fastener is attached via at least one an adhesive chemical, an adhesive tape and sewing.

Aspect 22: The information tag protection apparatus of any preceding claim, wherein the one vertical strap goes through an eye of the rope sling, and then goes back into the rectangular base as the rectangular base along with the horizontal straps is wrapped around the rope sling, until the horizontal straps completely wrap around the rope sling with the tag secured underneath, wherein the hook and loop fastener on the vertical strap engages with the hook and loop fastener on the rectangular base, and the hook and loop fastener on one side of the horizontal straps engage with the hook and loop fastener on the other side of the horizontal straps as the horizontal straps wrap around the rope sling.

Aspect 23: The information tag protection apparatus of any preceding claim, wherein the hook and loop fastener includes a male hook and loop strip with hooks on one side and a female hook and loop strip with loops on the other side.

Aspect 24: The information tag protection apparatus of any preceding claim, wherein the two longer sides of the rectangular base, the shorter side of the rectangular base that aligns with the one vertical strap and the one vertical strap include female hook and loop strips on one side of the information tag protection apparatus, wherein the shorter edge of the rectangular base opposite to the shorter edge that aligns with the one vertical strap, and the two longer sides of the rectangular base along with the two horizontal straps include male hook and loop strips on the other side of the information tag protection apparatus.

Aspect 25: The information tag protection apparatus of any preceding claim, wherein the one vertical strap goes through an eye of the rope sling, and is turned back towards the rectangular base such that the hook and loop female strip of the one vertical strap is visible, then the rectangular base along with the horizontal straps is wrapped around the rope sling, until the horizontal straps completely wrap around the rope sling with the tag secured underneath, wherein the hook and loop male strip on the rectangular base engages with the hook and loop female strip on the vertical strap, and the hook and loop female strip on the horizontal straps engages with the hook and loop male strip of the rectangular base as the horizontal straps wrap around the rope sling.

Aspect 26: The information tag protection apparatus of any preceding claim, wherein the position of the hook and loop male strips and the hook and loop female strips is interchanged.

Aspect 27: The information tag protection apparatus of any preceding claim, wherein the alignment of the horizontal straps and the vertical strap is interchanged, such that each horizontal strap extending away from the rectangular base along each of the shorter two opposite edges of the rectangular base respectively, wherein the at least one vertical strap includes a single vertical strap extending away from the rectangular base along one of the longer edges of the rectangular base.

Aspect 28: The information tag protection apparatus of any preceding claim, wherein the at least one horizontal strap includes three horizontal straps, wherein the two horizontal straps extending away from the rectangular base along each of the longer two opposite edges of the rectangular base respectively and the third horizontal strap extending away from the rectangular base between the two horizontal straps.

Aspect 29: The information tag protection apparatus of any preceding claim, wherein the third horizontal strap is attached to at least one the shorter edges of the rectangular base.

Aspect 30: The information tag protection apparatus of any preceding claim, wherein the number of straps in the at least one horizontal strap is based on the size of the information tag protection apparatus, wherein a smaller information tag protection apparatus includes two horizontal straps, wherein a bigger information tag protection apparatus includes three horizontal straps.

Aspect 31: The information tag protection apparatus of any preceding claim, wherein the at least one horizontal strap includes two horizontal straps forming a lining along each of the longer two opposite edges of the rectangular base respectively, wherein the at least one vertical strap includes a single vertical strap forming a lining along one of the shorter edges of the rectangular base, wherein the length of each horizontal strap is longer than the length of the longer edge of the rectangular base and the length of the vertical strap is longer than the length of the shorter edge of the rectangular base.

Aspect 32: The information tag protection apparatus of any preceding claim, wherein the size of the information tag protection apparatus varies with respect to the size of the lifting device.

Aspect 33: The information tag protection apparatus of any preceding claim, wherein the apparatus comprises a rectangular base of size 3.5″×7″ with 4″ long horizontal straps to wrap around a small rigging rope sling with a 4″ eye loop that secures the information tag protection apparatus to the rigging rope sling.

Aspect 34: The information tag protection apparatus of any preceding claim, wherein the apparatus comprises a rectangular base of size 5.25″×8.5″ with 6.25″ long horizontal straps to wrap around a small rigging rope sling with a 6″ eye loop that secures the information tag protection apparatus to the rigging rope sling.

Aspect 35: The information tag protection apparatus of any preceding claim, wherein the apparatus includes a rectangular base of size 5.25″×17″ with 6.25″ long horizontal straps to wrap around a small rigging rope sling with a 7″ eye loop that secures the information tag protection apparatus to the rigging rope sling.

Aspect 36: A method for attaching an information tag protection apparatus for a rope sling, the information tag protection apparatus comprising a rectangular base to cover a tag, at least one horizontal strap attached along at least one edge of the rectangular base; and at least one vertical strap attached along at least one edge of the rectangular base, such that the at least one vertical strap is attached in a direction perpendicular to the at least one horizontal strap, the method comprising: a) pulling the at least one vertical strap through the eye of the rope sling and back towards the rectangular base; b) wrapping the rectangular base along with the at least one horizontal strap around the rope sling until the horizontal straps completely with the tag secured underneath.

Aspect 37: The method of any preceding claim, configured to protect the tag, wherein the tag including one or more of capacity information, identification information and brand information.

Aspect 38: The method of any preceding claim, wherein protecting the tag includes keeping the information on the tag legible.

Aspect 39: The method of any preceding claim, wherein the tag and the information tag protection apparatus complies with the guidelines of the Occupational Safety and Health Administration (OSHA), wherein the guidelines include that the tag must me attached and readable so that a user can ensure proper usage.

Aspect 40: The method of any preceding claim, wherein the tag is at least one of a paper tag, a cloth tag, a plastic tag, a metal tag and an RFID tag.

Aspect 41: The method of any preceding claim securely removably attaches the information tag protection apparatus to the rope sling.

Aspect 42: The method of any preceding claim, wherein the rectangular base covers and protects the tag from at least one of being dislodged and being damaged.

Aspect 43: The method of any preceding claim, wherein the rectangular base is made of a material that is both pliable and tough.

Aspect 44: The method of any preceding claim, wherein the rectangular base is made of neoprene fabric.

Aspect 45: The method of any preceding claim, wherein the rectangular base includes a window made using a transparent, pliable and tough material, wherein the information on the tag is visible through the window.

Aspect 46: The method of any preceding claim, wherein the window is made of gauge clear vinyl.

Aspect 47: The method of any preceding claim, wherein the at least one horizontal strap tightly secures the tag in place on the rope sling.

Aspect 48: The method of any preceding claim, wherein the at least one vertical strap keeps the rectangular base from sliding down the rope sling.

Aspect 49: The method of any preceding claim, wherein the at least one horizontal strap includes two horizontal straps, wherein each horizontal strap extending away from the rectangular base along each of the longer two opposite edges of the rectangular base respectively, wherein the at least one vertical strap includes a single vertical strap extending away from the rectangular base along one of the shorter edges of the rectangular base.

Aspect 50: The method of any preceding claim, wherein the edges of the rectangular base, the two horizontal straps and the one vertical strap include a fastener means to secure the rectangular base, the one vertical strap and the two horizontal straps on a rope sling.

Aspect 51: The method of any preceding claim, wherein the fastener means are buttons and buttonholes.

Aspect 52: The method of any preceding claim, wherein the fastener means is hook and loop fastener, wherein the edges of the rectangular base are lined with hook and loop fastener on both sides, wherein the two horizontal straps and the one vertical strap include a hook and loop fastener on just one side.

Aspect 53: The method of any preceding claim, wherein the hook and loop fastener is attached via at least one an adhesive chemical, an adhesive tape and sewing.

Aspect 54: The method of any preceding claim, wherein the one vertical strap goes through an eye of the rope sling, and then goes back into the rectangular base as the rectangular base along with the horizontal straps is wrapped around the rope sling, until the horizontal straps completely wrap around the rope sling with the tag secured underneath, wherein the hook and loop fastener on the vertical strap engages with the hook and loop fastener on the rectangular base, and the hook and loop fastener on one side of the horizontal straps engage with the hook and loop fastener on the other side of the horizontal straps as the horizontal straps wrap around the rope sling.

Aspect 55: The method of any preceding claim, wherein the hook and loop fastener includes a male hook and loop strip with hooks on one side and a female hook and loop strip with loops on the other side.

Aspect 56: The method of any preceding claim, wherein the two longer sides of the rectangular base, the shorter side of the rectangular base that aligns with the one vertical strap and the one vertical strap include female hook and loop strips on one side of the information tag protection apparatus, wherein the shorter edge of the rectangular base opposite to the shorter edge that aligns with the vertical strap, and the two longer sides of the rectangular base along with the two horizontal straps include male hook and loop strips on the other side of the information tag protection apparatus.

Aspect 57: The method of any preceding claim, wherein the one vertical strap goes through an eye of the rope sling, and is turned back towards the rectangular base such that the hook and loop female strip of the one vertical strap is visible, then the rectangular base along with the horizontal straps is wrapped around the rope sling, until the horizontal straps completely wrap around the rope sling with the tag secured underneath, wherein the hook and loop male strip on the rectangular base engages with the hook and loop female strip on the vertical strap, and the hook and loop female strip on the horizontal straps engages with the hook and loop male strip of the rectangular base as the horizontal straps wrap around the rope sling.

Aspect 58: The method of any preceding claim, wherein the position of the hook and loop male strips and the hook and loop female strips is interchanged.

Aspect 59: The information tag protection apparatus of any preceding claim, wherein the alignment of the horizontal straps and the vertical strap is interchanged, such that each horizontal strap extending away from the rectangular base along each of the shorter two opposite edges of the rectangular base respectively, wherein the at least one vertical strap includes a single vertical strap extending away from the rectangular base along one of the longer edges of the rectangular base.

Aspect 60: The method of any preceding claim, wherein the at least one horizontal strap includes three horizontal straps, wherein the two horizontal straps extending away from the rectangular base along each of the longer two opposite edges of the rectangular base respectively and the third horizontal strap extending away from the rectangular base between the two horizontal straps.

Aspect 61: The method of any preceding claim, wherein the third horizontal strap is attached to at least one the shorter edges of the rectangular base.

Aspect 62: A method for providing a safety measure for lifting a load using a rope sling, the method comprising the steps of: observing a tag including the capacity information of the rope sling, wherein the tag provides information about a predetermined maximum static force which may be applied to the rope sling during lifting, wherein the tag is protected using an information tag protection apparatus; and loading the rope sling based on the predetermined maximum static force.

Aspect 63: The method of any preceding claim, wherein the information tag protection apparatus comprising a rectangular base to cover a tag, at least one horizontal strap attached along at least one edge of the rectangular base, and at least one vertical strap attached along at least one edge of the rectangular base, such that the at least one vertical strap is attached in a direction perpendicular to the at least one horizontal strap, the method for attaching an information tag protection apparatus for the rope sling comprising: a) pulling the at least one vertical strap through an eye of the rope sling and back towards the rectangular base; and b) wrapping the rectangular base along with the at least one horizontal strap around the rope sling until the at least one horizontal strap completely with the tag secured underneath.

Aspect 64: The method of any preceding claim, wherein the tag and the information tag protection apparatus complies with the guidelines of the Occupational Safety and Health Administration (OSHA), wherein the guidelines include that the tag must me attached and readable so that a user can ensure proper usage.

Aspect 65: The method of any preceding claim, wherein the tag is at least one of a paper tag, a cloth tag, a plastic tag, a metal tag and an RFID tag.

Aspect 66: The method of any preceding claim, wherein the information tag protection apparatus is configured to securely removably attach to the rope sling.

Aspect 67: The method of any preceding claim, wherein the rectangular base covers and protects the tag from at least one of being dislodged and being damaged.

Aspect 68: The method of any preceding claim, wherein the rectangular base is made of a material that is both pliable and tough.

Aspect 69: The method of any preceding claim, wherein the rectangular base includes a window made using a transparent, pliable and tough material, wherein the information on the tag is visible through the window.

Aspect 70: The method of any preceding claim, wherein the window is made of gauge clear vinyl.

Aspect 71: The method of any preceding claim, wherein the at least one horizontal strap tightly secures the tag in place on the rope sling, wherein the at least one vertical strap keeps the rectangular base from sliding down the rope sling.

Aspect 72: The method of any preceding claim, wherein the at least one horizontal strap includes two horizontal straps, wherein each horizontal strap extending away from the rectangular base along each of the longer two opposite edges of the rectangular base respectively, wherein the at least one vertical strap includes a single vertical strap extending away from the rectangular base along one of the shorter edges of the rectangular base.

Aspect 73: The method of any preceding claim, wherein the edges of the rectangular base, the two horizontal straps and the one vertical strap include a fastener means to secure the rectangular base, the one vertical strap and the two horizontal straps on a rope sling.

Aspect 74: The method of any preceding claim, wherein the fastener means is hook and loop fastener, wherein the edges of the rectangular base are lined with hook and loop fastener on both sides, wherein the two horizontal straps and the one vertical strap include a hook and loop fastener on just one side.

Aspect 75: The method of any preceding claim, wherein the at least one horizontal strap includes three horizontal straps, wherein the two horizontal straps extending away from the rectangular base along each of the longer two opposite edges of the rectangular base respectively and the third horizontal strap extending away from the rectangular base between the two horizontal straps.

Aspect 76: An information tag protection apparatus for protecting a tag for a lifting device, the information tag protection apparatus comprising: a) a base to cover the tag; b) at least one horizontal strap attached along at least one edge of the base; and c) at least one vertical strap attached to the base such that the direction of the at least one vertical strap is perpendicular to the direction of the at least one horizontal strap.

Aspect 77: The information tag protection apparatus of any preceding claim, wherein the shape of the base is one of a square, a rectangle, a triangle, a circle, an oval, and a polygon.

Aspect 78: The information tag protection apparatus of any preceding claim, wherein the at least one vertical strap goes through an eye of the lifting device, back into the base as the base along with the at least one horizontal strap is wrapped around the lifting device, until the at least one horizontal strap completely wraps around the lifting device with the tag secured underneath the base.

Aspect 79: The information tag protection apparatus of any preceding claim, wherein the base comprises two halves connected by a pivoting means.

Aspect 80: The information tag protection apparatus of any preceding claim, wherein the two halves of the base are releasably connected to allow for the base to be opened and closed.

Aspect 81: The information tag protection apparatus of any preceding claim, wherein when the two halves are closed, one or more aperture portions are formed at the top and/or bottom of the base, and are configured to secure different portions of the lifting device.

Aspect 82: The information tag protection apparatus of any preceding claim, wherein the base further comprises releasable locking mechanism configure to secure and release connection of the two halves.

Aspect 83: The information tag protection apparatus of any preceding claim, wherein the base comprises a flexible portion and a stiff portion, and is configured such that the hard portion of base is substantially the only portion of the base that is contact the rope sling.

Aspect 84: The information tag protection apparatus of any preceding claim, wherein the base comprises a plurality of securing means or connecting means, or a combination thereof.

Aspect 85: The information tag protection apparatus of any preceding claim, wherein the base comprises a first portion having a pivoting means and a second portion having s clamping mechanism.

Aspect 86: The information tag protection apparatus of any preceding claim, wherein the base comprises a fastener or vertical strap across the center portion.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. An information tag protection apparatus for protecting a tag for a lifting device, the information tag protection apparatus comprising:
a rectangular base to cover the tag;
at least one horizontal strap attached along at least one edge of the rectangular base; and
at least one vertical strap attached along at least one edge of the rectangular base, such that the at least one vertical strap is attached in a direction perpendicular to the at least one horizontal strap;
wherein the at least one vertical strap is configured to go through an eye of the lifting device, back into the rectangular base as the rectangular base along with the at least one horizontal strap is wrapped around the lifting device, until the at least one horizontal strap is completely wrap around the lifting device with the tag secured underneath the rectangular base.

2. The information tag protection apparatus of claim 1, wherein the tag comprises one or more of: capacity information, identification information and brand information.

3. The information tag protection apparatus of claim 1, wherein the tag comprises at least one of a paper tag, a cloth tag, a plastic tag, a metal tag and an RFID tag.

4. The information tag protection apparatus of claim 1, wherein the apparatus is configured to removably securely attach to the lifting device.

5. The information tag protection apparatus of claim 1, wherein the lifting device is at least one of a rigging device, a safety device, rope sling and a safety sling.

6. The information tag protection apparatus of claim 1, wherein the base further comprises a window made using a transparent, pliable and tough material, and wherein the information on the tag is visible through the window.

7. The information tag protection apparatus of claim 1, wherein the at least one horizontal strap tightly secures the tag in place on the lifting device, and the least one vertical strap is configured to keep the rectangular base from sliding down the lifting device.

8. The information tag protection apparatus of claim 7, wherein the at least one horizontal strap comprises at least two horizontal straps, each horizontal strap extending away from the rectangular base along each of the longer two opposite edges of the rectangular base respectively, wherein the at least one vertical strap includes a single vertical strap extending away from the rectangular base along one of the shorter edges of the rectangular base; and wherein the edges of the rectangular base, the two horizontal straps and the one vertical strap comprise a fastener means configured to secure the rectangular base and straps on a rope sling.

9. The information tag protection apparatus of claim 8, wherein the fastener means include hook and loop fastener, wherein the edges of the rectangular base are lined with hook and loop fastener on both sides, wherein the two horizontal straps and the one vertical strap include a hook and loop fastener on just one side.

10. The information tag protection apparatus of claim 19, wherein the at least one vertical strap is configured to go through an eye of the rope sling, and then go back into the rectangular base as the rectangular base along with the horizontal straps is wrapped around the rope sling, until the horizontal straps completely wrap around the rope sling with the tag secured underneath; wherein the fastener on the vertical strap engages with the fastener on the rectangular base, and the fastener on one side of the horizontal straps engage with the fastener on the other side of the horizontal straps as the horizontal straps wrap around the rope sling.

11. The information tag protection apparatus of claim 10, wherein the at least one horizontal strap includes three horizontal straps, wherein the two horizontal straps extending away from the rectangular base along each of the longer two opposite edges of the rectangular base respectively and the third horizontal strap extending away from the rectangular base between the two horizontal straps.

12. The information tag protection apparatus of claim 11, wherein the at least one horizontal strap includes two horizontal straps forming a lining along each of the longer two opposite edges of the rectangular base respectively, wherein the at least one vertical strap includes a single vertical strap forming a lining along one of the shorter edges of the rectangular base, wherein the length of each horizontal strap is longer than the length of the longer edge of the rectangular base and the length of the vertical strap is longer than the length of the shorter edge of the rectangular base.

13. The information tag protection apparatus of claim 1, wherein the base comprises two halves connected by a pivoting means, and a releasable locking mechanism configured to secure and release connection of the two halves.

14. A method for attaching an information tag protection apparatus for a rope sling, the method comprising:
a) providing an information tag protection apparatus configured to cover the tag, the apparatus comprising: a rectangular base to cover a tag, at least one horizontal strap attached along at least one edge of the rectangular base; at least one vertical strap attached along at least one edge of the rectangular base, such that the at least one vertical strap is attached in a direction perpendicular to the at least one horizontal strap, and a fastener means to secure the rectangular base and the straps on a rope sling;
b) pulling the at least one vertical strap through an eye of the rope sling and back towards the rectangular base; and
c) wrapping the rectangular base along with the at least one horizontal strap around the rope sling until the horizontal straps completely with the tag secured underneath.

15. The method of claim 14, configured to protect the tag, wherein the comprises one or more of capacity information, identification information and brand information.

16. The method of claim 14, wherein the tag comprises at least one of a paper tag, a cloth tag, a plastic tag, a metal tag and an RFID tag.

17. The method of claim 14, further comprising securely removably attaching the information tag protection apparatus to the rope sling.

18. The method of claim 17, wherein the at least one horizontal strap comprises two horizontal straps, wherein each horizontal strap extends away from the rectangular base along each of the longer two opposite edges of the rectangular base respectively, wherein the at least one vertical strap includes a single vertical strap extending away from the rectangular base along one of the shorter edges of the rectangular base.

19. The method of claim 18, further comprising extending the at least one vertical strap goes through an eye of the rope sling, and then extending the strap back into the rectangular base as the rectangular base along with the horizontal straps is wrapped around the rope sling, until the horizontal straps completely wrap around the rope sling with the tag secured underneath, wherein fastener on the vertical strap engages with fastener on the rectangular base, and fastener on one side of the horizontal straps engage with fastener on the other side of the horizontal straps as the horizontal straps wrap around the rope sling.

20. The method of claim 18, further comprising a third horizontal strap, wherein the two horizontal straps extending away from the rectangular base along each of the longer two opposite edges of the rectangular base respectively and the third horizontal strap extending away from the rectangular base between the two horizontal straps.
